(19) United States
(12) Patent Application Publication
(10) Pub. No.: US 2025/0106340 A1
(43) Pub. Date: Mar. 27, 2025

(54) INFORMATION PROCESSING SYSTEM, NON-TRANSITORY COMPUTER READABLE MEDIUM STORING PROGRAM, AND INFORMATION PROCESSING METHOD

(71) Applicant: FujiFilm Business Innovation Corp., Tokyo (JP)

(72) Inventor: Toshihiko TANABE, Kanagawa (JP)

(73) Assignee: FujiFilm Business Innovation Corp., Tokyo (JP)

(21) Appl. No.: 18/583,175

(22) Filed: Feb. 21, 2024

(30) Foreign Application Priority Data
Sep. 22, 2023 (JP) 2023-158506

(51) Int. Cl. H04N 1/32; H04N 1/00

(52) U.S. Cl. CPC H04N 1/32128; H04N 1/00212

(57) ABSTRACT

An information processing system includes: one or a plural processors; and one or a plural recording units that record attribute data associated with actual data generated by an apparatus that communicates with the processor, in which the processor is configured to transmit the attribute data recorded in the recording unit to an external apparatus; and make the actual data available to the external apparatus in a case where the attribute data is requested from the external apparatus.

### CROSS-REFERENCE TO RELATED APPLICATIONS

This application is based on and claims priority under 35 USC 119 from Japanese Patent Application No. 2023-158506 filed Sep. 22, 2023.

### BACKGROUND

### (i) Technical Field

The present disclosure relates to an information processing system, a non-transitory computer readable medium storing a program, and an information processing method.

### (ii) Related Art

For example, JP2021-163983A discloses, in a case where a setting screen for making a setting regarding new transmission target image data is to be provided, a setting screen for making a setting regarding new transmission target image data in a state in which a setting, among settings stored in a storage unit, which is associated with the same type of image data as the new transmission target image data and is stored in association with information regarding the same user as a user who makes the setting regarding the new transmission target image data, is reflected.

### SUMMARY

Aspects of non-limiting embodiments of the present disclosure relate to an information processing system, a non-transitory computer readable medium storing a program, and an information processing method that enable an external apparatus to use actual data generated by an apparatus that cannot directly communicate with the external apparatus.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: one or a plurality of processors; and one or a plurality of recording units that record attribute data associated with actual data generated by an apparatus that communicates with the processor, in which the processor is configured to transmit the attribute data recorded in the recording unit to an external apparatus; and make the actual data available to the external apparatus in a case where the attribute data is requested from the external apparatus.

### BRIEF DESCRIPTION OF THE DRAWINGS

Exemplary embodiment(s) of the present invention will be described in detail based on the following figures, wherein:

FIG. 1 is a diagram showing a system configuration of a machine learning system according to a first exemplary embodiment;

FIG. 2 is a block diagram showing a hardware configuration of an image forming apparatus according to the first exemplary embodiment;

FIG. 3 is a block diagram showing a hardware configuration of a cloud server according to the first exemplary embodiment;

FIG. 4 is a block diagram showing a relationship between a digital shadow provided in the cloud server and the image forming apparatus according to the first exemplary embodiment;

FIG. 5 is a sequence diagram showing a state in which the image forming apparatus and the digital shadow according to the first exemplary embodiment communicate with each other and metadata associated with image data is created;

FIG. 6 is a sequence diagram showing a state in which the image forming apparatus and the digital shadow according to the first exemplary embodiment communicate with each other and the metadata associated with the image data is updated;

FIG. 7 is a sequence diagram showing a state in which a machine learning apparatus, the digital shadow, and the image forming apparatus according to the first exemplary embodiment communicate with each other and a machine learned model is generated;

FIG. 8 is a flowchart in which the cloud server according to the first exemplary embodiment searches for metadata included in the digital shadow;

FIG. 9 is a sequence diagram showing a state in which a machine learning apparatus, a digital shadow, and an image forming apparatus according to a second exemplary embodiment communicate with each other and a machine learned model is generated; and

FIG. 10 is a sequence diagram showing a state in which a machine learning apparatus, a digital shadow, and an image forming apparatus according to a third exemplary embodiment communicate with each other and a machine learned model is generated.

### DETAILED DESCRIPTION

Hereinafter, an example of an exemplary embodiment of the present disclosure will be described with reference to the drawings. The identical reference numerals are given to the identical or equivalent components and parts in each drawing. In addition, the dimensional ratios in the drawings are exaggerated for convenience of description and may differ from the actual ratios.

In the following description, a user refers to a person who uses an image forming apparatus 32 to create, correct, or delete image data 44 of a document, or a person who uses a machine learning apparatus 50 to generate a learned model. The number of users is not limited, and includes a case where a plurality of image forming apparatuses 32 or a plurality of functions are used.

### First Exemplary Embodiment

### Machine Learning System 10

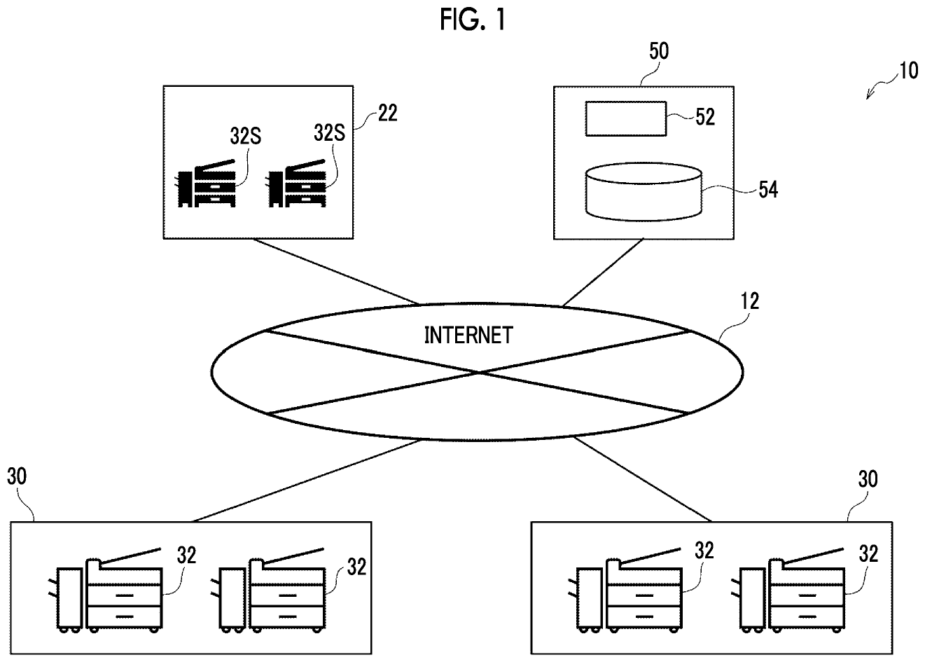

FIG. 1 is a diagram showing a system configuration of a machine learning system 10 according to an exemplary embodiment of the present disclosure. As shown in FIG. 1, the machine learning system 10 of the exemplary embodiment of the present disclosure has a configuration in which a plurality of image forming apparatuses 32 each installed at a plurality of bases 30, a machine learning apparatus 50, and a cloud server 22 are connected via the Internet 12. In the following description, the image forming apparatuses 32 are all similar apparatuses, and will not be distinguished unless specifically mentioned. Furthermore, in the following description, the description of the image forming apparatus 32 includes both cases where the image forming apparatus 32 refers to a single apparatus and to any one of a plurality of apparatuses.

### Image Forming Apparatus 32

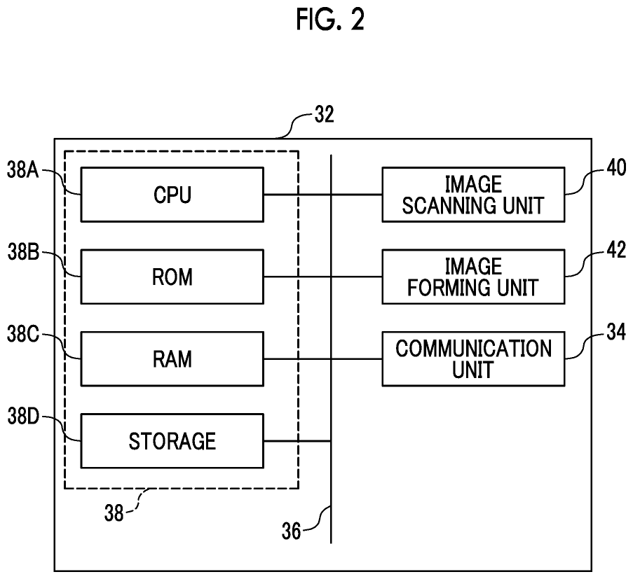

The image forming apparatus 32 is a so-called multifunction peripheral apparatus that is connected to each other via a network in the base 30 and has a plurality of functions such as a printing function, a scanning function, a copying function, and a facsimile function. The image forming apparatus 32 is an example of an “apparatus that communicates with the processor” in the present exemplary embodiment. FIG. 2 is a block diagram showing a hardware configuration of the image forming apparatus 32 according to the present exemplary embodiment. Further, as shown in FIG. 2, the image forming apparatus 32 includes a control device 38, an image scanning unit 40, an image forming unit 42, and a communication unit 34. These components are connected to each other via a control bus 36.

The control device 38 is a device that controls each unit of the image forming apparatus 32. The control device 38 has a function as a computer, and as shown in FIG. 2, the control device 38 includes a central processing unit (CPU) 38A, a read only memory (ROM) 38B, a random access memory (RAM) 38C, and a storage 38D. Each of the CPU 38A, the ROM 38B, the RAM 38C, and the storage 38D is connected to each other via the control bus 36.

The CPU 38A is a central arithmetic processing unit, and executes various programs including an information processing program such as an information synchronization program, and controls each unit. The ROM 38B stores various programs including an information processing program and various types of data. The RAM 38C temporarily stores, as a work area, the program or the data.

The storage 38D is constituted by a storage medium such as a hard disk drive (HDD), a solid state drive (SSD), or a flash memory, and stores various programs including an operating system and various types of data. Here, the various types of data include data such as various settings and states of the image forming apparatus 32. The information processing program may be stored in the storage 38D.

In the control device 38, the CPU 38A reads various programs including an information processing program from the ROM 38B or the storage 38D, and executes the programs using the RAM 38C as a work area. By executing the information processing program by the CPU 38A, various functions of controlling each unit of the image forming apparatus 32 are implemented.

The image scanning unit 40 is a component (for example, a scanner) that scans an image of a document. The image scanning unit 40 generates image data 44 by optically scanning the image of the document and converting the scanned image into a digital signal. In this description, as an example, it is assumed that the document includes text.

The image forming unit 42 is a component that forms an image on a recording medium such as paper. The image forming unit 42 forms an image on a recording medium using, for example, an electrophotographic method that performs charging, exposure, development, transfer, and fixing steps. The image forming unit 42 may form an image on the recording medium using other methods such as an ink jet method.

The communication unit 34 is a component for communicating with other devices such as the cloud server 22 and the machine learning apparatus 50. Specifically, the communication unit 34 communicates with other devices by using communication means such as wired, wireless, Internet 12, intranet, and public lines such as telephone lines. The communication means may be communication means using voice, light, vibration, images, or the like.

The network connecting each image forming apparatus 32 within the base 30 is, for example, a local network incorporating a boundary-type security system such as a firewall.

In the present exemplary embodiment, in a case where the image forming apparatus 32 makes an inquiry to the cloud server 22 via the communication unit 34, the communication unit 34 is configured to be able to receive communication from the cloud server 22 as a response to the inquiry.

In the image forming apparatus 32, for example, the image scanning unit 40 scans an image of a document to generate image data 44, thereby executing scanning processing using a scanning function. Further, in the image forming apparatus 32, for example, facsimile processing using a facsimile function is executed by transmitting image data 44 generated by scanning an image of a document through the image scanning unit 40 to another device such as another multifunction peripheral.

### Machine Learning Apparatus 50

The machine learning apparatus 50 according to the present exemplary embodiment is an example of an “external apparatus” in the present exemplary embodiment, and includes a communication unit (not shown), a control device 52, and a recording device 54. The machine learning apparatus 50 performs machine learning to detect feature amounts included in the image data 44 by collecting and analyzing a large amount of image data 44. The control device 52 is a device that controls each unit of the machine learning apparatus 50, and includes, as an example, a CPU (not shown), a ROM (not shown), a RAM (not shown), and the recording device 54. Each of these configurations (not shown) and the recording device 54 are connected to each other via a control bus (not shown). Furthermore, the machine learning apparatus 50 collects the image data 44 in accordance with a procedure to be described later by the control device 52 reading a program recorded in the recording device 54. The machine learning method is not particularly limited, but for example, learning related to image recognition in which a neural network is formed is assumed.

In the present exemplary embodiment, the machine learning apparatus 50 uses images acquired by the image forming apparatus 32 for machine learning. More specifically, the machine learning apparatus 50 receives image data 44 acquired by the image forming apparatus 32 via the Internet 12, and detects feature amounts from the plurality of pieces of image data 44.

### Cloud Server 22

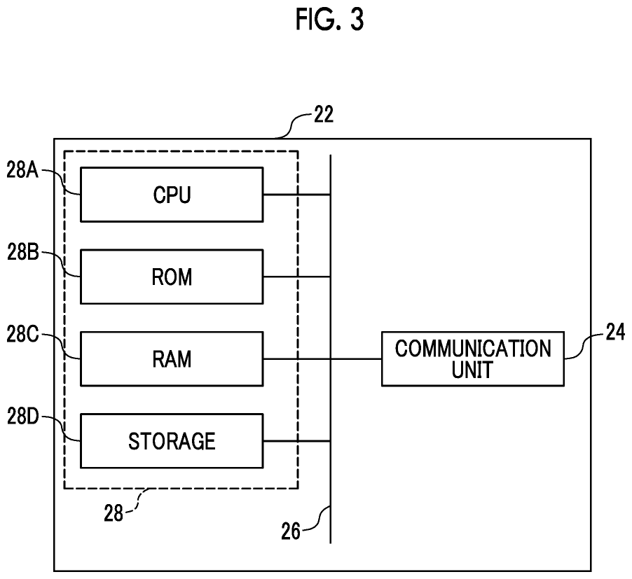

The cloud server 22 is an example of an “information processing system” in the technology of the present disclosure, and includes a control device 28 and a communication unit 24, as shown in FIG. 3. Further, the control device 28 has a function as a computer, and includes a CPU 28A, a ROM 28B, a RAM 28C, and a storage 28D, as shown in FIG. 3. These components are connected to each other via a control bus 26.

The specific functions and configurations of the control device 28 and the communication unit 24 provided in the cloud server 22 are the same as the functions and configurations of the control device 28 and the communication unit 24 provided in the image forming apparatus 32, except for the performance (processing capacity) of each configuration. That is, the CPU 28A, the ROM 28B, the RAM 28C, and the storage 28D provided in the cloud server 22 are the same as the CPU 38A, the ROM 38B, the RAM 38C, and the storage 38D provided in the image forming apparatus 33, except for the performance of each configuration. Furthermore, in the present exemplary embodiment, the CPU 28A provided in the cloud server 22 is an example of a “processor” in the present disclosure, and the storage 28D is an example of a “recording unit” in the present disclosure.

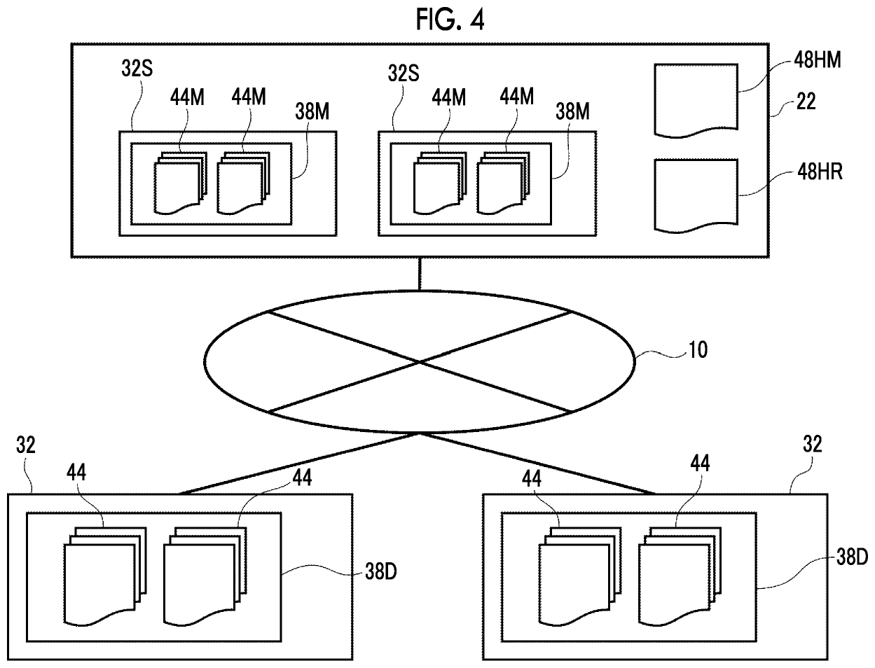

Further, as shown in FIG. 4, the cloud server 22 stores data of a digital shadow 32S as a virtual device corresponding to the image forming apparatus 32 as a physical device connected via the Internet 12 in the storage 28D. Further, the cloud server 22 executes the behavior of the digital shadow 32S by the CPU 28A executing a program stored in the storage 28D. In the following description, it is assumed that all virtual operations performed by the digital shadow 32S are executed by the CPU 28A of the cloud server 22. Furthermore, in the description of the present exemplary embodiment, although not shown or distinguished, it is assumed that the digital shadow 32S is formed for each image forming apparatus 32 shown in FIG. 1.

### Digital Shadow 32S

The digital shadow 32S is a virtual device that reflects the state of the image forming apparatus 32 (for example, the number of prints, operating time, and the like), and is created based on the state of the image forming apparatus 32 recorded in the storage 28D as data. For example, in a case where an inquiry is received from the machine learning apparatus 50, the digital shadow 32S notifies the machine learning apparatus 50 of the state of the image forming apparatus 32 by replying with information regarding a model or a function of the image forming apparatus 32 that the digital shadow 32S has, and information regarding a state of the image forming apparatus 32.

Further, the digital shadow 32S records the image data 44 stored in the storage 38D of the image forming apparatus 32 as metadata 44M. More specifically, in a case where the image of the document scanned by the image scanning unit 40 is stored in the storage 38D as the image data 44, the image forming apparatus 32 notifies the digital shadow 32S of the information included in the image data 44. Then, the digital shadow 32S generates metadata 44M corresponding to the image data 44, and stores the data in the storage 38M of the digital shadow 32S. The metadata 44M refers to data obtained by extracting attributes of an image included in the image data 44.

For example, in a case where the document scanned by the image forming apparatus 32 is a written document, text of the written document is recorded as an image in the image data 44 recorded in the storage 38D of the image forming apparatus 32. On the other hand, in the metadata 44M recorded by the digital shadow 32S in the storage 38M, data obtained by recognizing text included in the image data 44 as text data through optical character recognition (OCR) is recorded. Further, the metadata 44M has information indicating a feature of the image data 44. The information indicating this feature may be information obtained by applying a feature amount extraction technology known as an image processing technology. Further, the metadata 44M includes identification information for identifying the image forming apparatus 32 that scanned the image data 44, and information regarding a scanning method used in scanning the image data 44.

The image data 44 is an example of “actual data generated by an apparatus that communicates with the processor” in the present exemplary embodiment. In addition, the metadata 44M is an example of “attribute data associated with the actual data” in the present exemplary embodiment.

Further, as shown in FIG. 4, in a case where the cloud server 22 communicates with the machine learning apparatus 50, the cloud server 22 records the communication history. More specifically, the cloud server 22 stores the number of times the machine learning apparatus 50 requests the metadata 44M as metadata request history data 48HM in the storage 28D in a procedure to be described later. In addition, the cloud server 22 stores the number of times the machine learning apparatus 50 requests the image data 44 as image data request history data 48HR in the storage 28D in a procedure to be described later. The metadata request history data 48HM is an example of a “history in which the attribute data is requested” in the present exemplary embodiment, and the image data request history data 48HR is an example of a “history in which the actual data is requested” in the present exemplary embodiment. Furthermore, the image data request history data 48HR may include a time at which the image data 44 is requested from the machine learning apparatus 50.

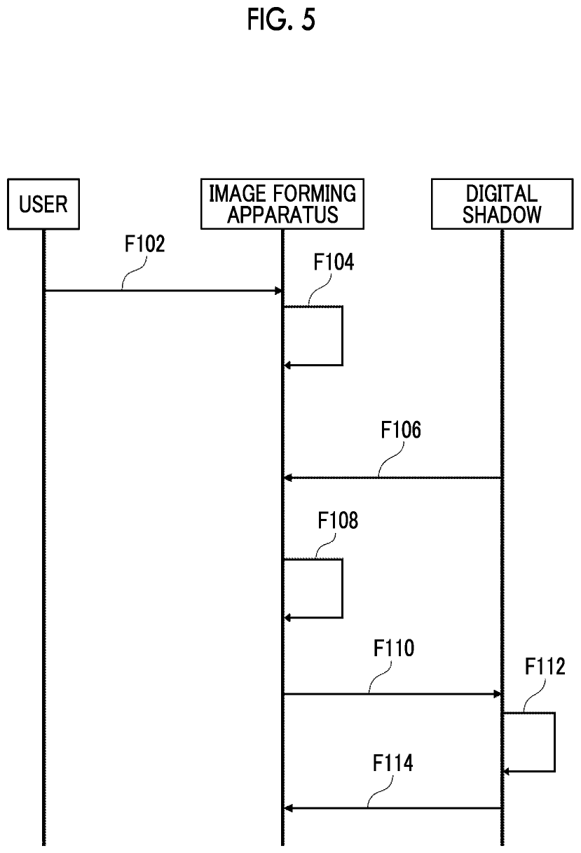

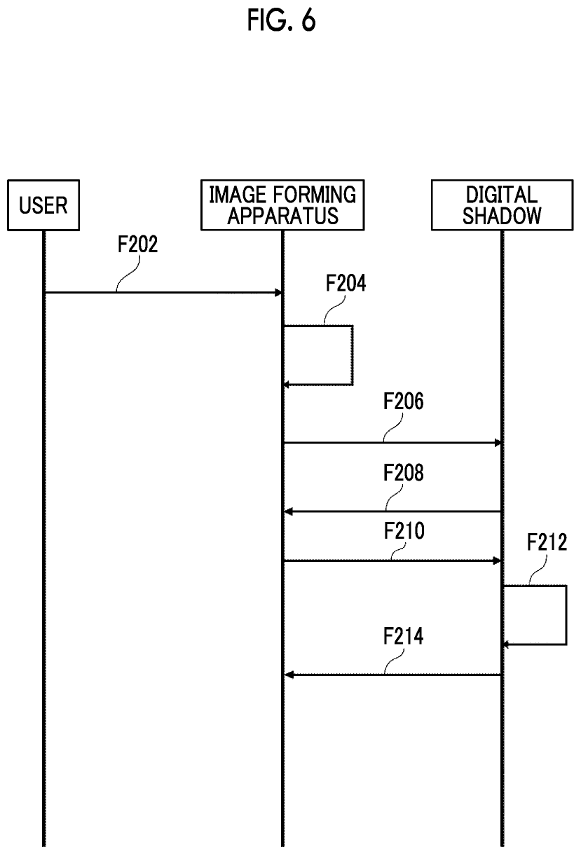

Subsequently, in the present exemplary embodiment, a state in which the metadata 44M is generated in the digital shadow 32S and a state in which the metadata 44M is updated will be described with reference to FIGS. 5 and 6.

First, a procedure will be described in which the image data 44 and the metadata 44M are generated and the metadata 44M is recorded in the storage 38M of the digital shadow 32S in the present exemplary embodiment. In the present exemplary embodiment, the document scanned by the user has a written document thereon, and text data can be scanned using OCR.

### Creation of Metadata 44M

FIG. 5 is a sequence diagram showing a state in which the image forming apparatus 32 and the digital shadow 32S according to the present exemplary embodiment communicate with each other and metadata 44M associated with the image data 44 is created. As shown in FIG. 5, in the present exemplary embodiment, metadata 44M is created by the procedure shown below.

First, in sequence F102, the user uses the image forming apparatus 32 to scan a document and form the image data 44.

Next, in sequence F104, the CPU 38A of the image forming apparatus 32 records the image data 44 of the document scanned in sequence F102 in the storage 38D of the image forming apparatus 32. Further, the CPU 38A of the image forming apparatus 32 performs OCR on the image data 44, scans text included in the image data 44, and records the scanned text data along with the image data 44.

Here, as shown in sequence F106, the digital shadow 32S performs synchronization processing on the image forming apparatus 32, that is, inquires whether there is any change in the information recorded in the storage 38D of the image forming apparatus 32. Then, the CPU 38A of the image forming apparatus 32 that has received the inquiry executes sequence F108.

In sequence F108, the CPU 38A of the image forming apparatus 32 generates metadata 44M from the image data 44 and the text data included in the image data 44. The metadata 44M may include information such as the color tone and resolution of the image data 44 in addition to the text data obtained by OCR.

Subsequently, in sequence F110, the CPU 38A of the image forming apparatus 32 transmits the metadata 44M generated in sequence F108 to the digital shadow 32S.

Then, in sequence F112, the digital shadow 32S records the metadata 44M received from the image forming apparatus 32 in the storage 38M of the digital shadow 32S. The metadata 44M of the digital shadow 32S also includes information indicating whether or not the image data 44 is recorded in the storage 38D of the image forming apparatus 32. In the present exemplary embodiment, at the time of sequence F112, it is also recorded that the image data 44 is recorded in the storage 38D of the image forming apparatus 32.

Then, in sequence F114, the digital shadow 32S notifies the image forming apparatus 32 that the metadata 44M corresponding to the image data 44 has been recorded in the storage 38M of the digital shadow 32S.

Subsequently, in the present exemplary embodiment, a state in which the metadata 44M recorded in the storage 38M of the digital shadow 32S is updated will be described. In the present exemplary embodiment, a case where the user deletes the image data 44 stored in the above procedure will be described as an example.

### Update of Metadata 44M

FIG. 6 is a sequence diagram showing a state in which the image forming apparatus 32 and the digital shadow 32S according to the present exemplary embodiment communicate with each other and the metadata 44M associated with the image data 44 is updated. As shown in FIG. 6, in the present exemplary embodiment, the metadata 44M is updated by the procedure shown below.

First, in sequence F202, the user operates the image forming apparatus 32 and inputs an instruction to delete the image data 44 recorded in the storage 38D of the image forming apparatus 32.

Next, in sequence F204, the CPU 38A of the image forming apparatus 32 deletes the image data 44 targeted in sequence F202 from the storage 38D of the image forming apparatus 32.

Next, as shown in sequence F206, the image forming apparatus 32 notifies the digital shadow 32S to request update of the metadata 44M. Then, the digital shadow 32S that has received the notification executes sequence F208.

In sequence F208, the CPU of the digital shadow 32S, that is, the CPU 28A of the cloud server 22, notifies the image forming apparatus 32 of information for receiving updates for the metadata 44M corresponding to the image data 44. Then, the CPU 38A of the image forming apparatus 32 that has received the notification executes sequence F210.

Subsequently, in sequence F210, the CPU 38A of the image forming apparatus 32 transmits a notification to the digital shadow 32S to delete the metadata 44M corresponding to the image data 44 deleted in sequence F204. Then, the digital shadow 32S that has received the notification executes sequence F212.

Then, in sequence F212, the digital shadow 32S updates the information of the metadata 44M corresponding to the image data 44 deleted in sequence F204, based on the notification to delete the metadata 44M received from the image forming apparatus 32. Specifically, the digital shadow 32S records that the image data 44 has been deleted from the storage 38D of the image forming apparatus 32 regarding information indicating whether or not the image data 44 corresponding to the metadata 44M is recorded in the storage 38D of the image forming apparatus 32.

Then, in sequence F214, the digital shadow 32S notifies the image forming apparatus 32 that the metadata 44M corresponding to the image data 44 has been deleted from the storage 38M of the digital shadow 32S.

By the way, as described above, the machine learning apparatus 50 in the present exemplary embodiment receives the image data 44 acquired by the image forming apparatus 32 via the Internet 12, and performs machine learning to detect feature amounts from the plurality of pieces of image data 44. However, in general, it is not advisable for security to allow an apparatus outside the base 30 to directly connect to the image forming apparatus 32 located within the firewall via the Internet 12. Therefore, in the configuration shown in FIG. 1, the machine learning apparatus 50 cannot obtain access permission to refer to the image data 44 recorded in the storage 38D of the image forming apparatus 32 in the base 30. In other words, as shown in FIG. 1, the image forming apparatus 32 located at the base 30 in the present exemplary embodiment cannot directly communicate with the machine learning apparatus 50.

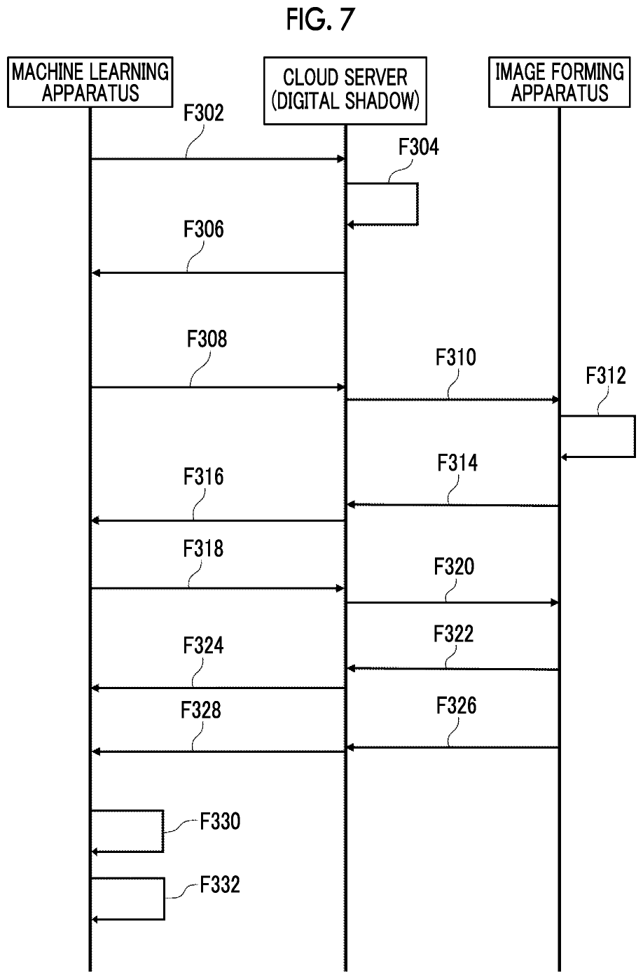

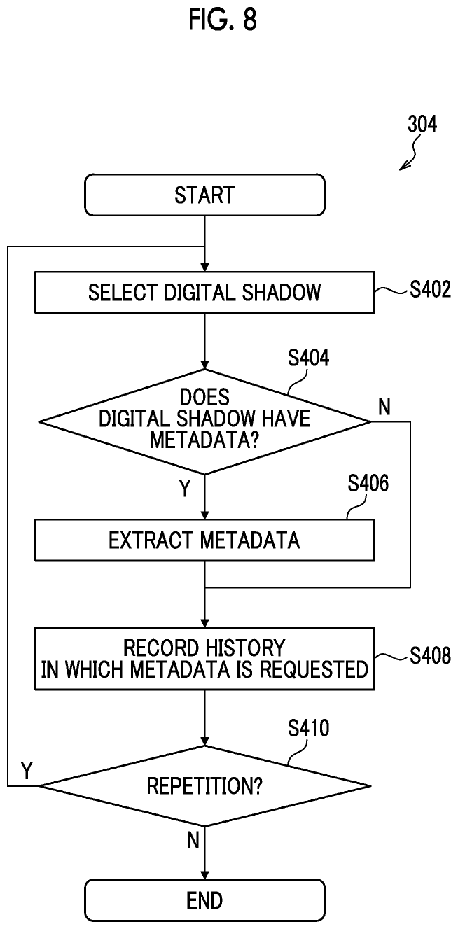

Next, a procedure will be described in which the cloud server 22 in the present exemplary embodiment cooperates with the machine learning apparatus 50 to execute the procedures shown in FIGS. 7 and 8, thereby making the image data 44 of the image forming apparatus 32 available to the machine learning apparatus 50.

### Procedure for Making Image Data 44 Available

FIG. 7 is a sequence diagram showing a state in which the machine learning apparatus 50, the digital shadow 32S, and the image forming apparatus 32 according to the exemplary embodiment of the present disclosure communicate with each other, and the machine learning apparatus 50 performs machine learning based on the image data 44 and generates a machine learned model. The CPU 28A of the cloud server 22, the CPU 38A of the image forming apparatus 32, and the CPU (not shown) of the machine learning apparatus 50 execute a series of procedures shown in FIG. 7 by reading programs stored in the storage 28D, the storage 38D, and the recording device 54, respectively. In a case where the machine learning apparatus 50 receives an instruction from a user (not shown), the machine learning apparatus 50 executes sequence F302 shown in FIG. 7.

First, in sequence F302, the machine learning apparatus 50 requests the digital shadow 32S to provide a list of image data 44 necessary for performing machine learning. More specifically, the machine learning apparatus 50 requests the cloud server 22, which virtually executes the behavior of the digital shadow 32S, for image data 44 having the target attributes (for example, resolution, color tone, presence or absence of text data, and the like) in machine learning.

Next, in sequence F304, the cloud server 22 searches for metadata 44M of the image data 44 having the attributes of the image data 44 requested in sequence F302, and extracts the metadata 44M. More specifically, the cloud server 22 extracts the metadata 44M according to the flowchart shown in FIG. 8.

First, in step S402, the CPU 28A of the cloud server 22 sets any digital shadow 32S recorded in the storage 28D as the digital shadow 32S that is a search target. Then, the CPU 28A of the cloud server 22 proceeds to step S404.

Next, in step S404, the CPU 28A of the cloud server 22 determines whether metadata 44M having the attribute requested in sequence F302 is recorded in the storage 38M of the digital shadow 32S as the search target in step S402. In a case where the CPU 28A of the cloud server 22 makes an affirmative determination in step S404, the process proceeds to step S406. On the other hand, in a case where the CPU 28A of the cloud server 22 makes a negative determination in step S404, the process proceeds to step S408.

Next, in step S406, the CPU 28A of the cloud server 22 extracts the metadata 44M recorded in the storage 38M of the digital shadow 32S that is searched for. Then, the CPU 28A of the cloud server 22 proceeds to step S408.

Next, in step S408, the CPU 28A of the cloud server 22 records the history in which the metadata 44M is requested for the digital shadow 32S as the search target in the storage 28D as metadata request history data 48HM. The metadata request history data 48HM recorded in step S408 may include a time at which the metadata 44M is requested in addition to the determination result in step S404. Then, the CPU 28A of the cloud server 22 proceeds to step S410.

Next, in step S410, the CPU 28A of the cloud server 22 determines the presence or absence of another digital shadow 32S that is not the search target in step S402. Then, in a case where the CPU 28A of the cloud server 22 makes an affirmative determination in step S410, the process proceeds to step S402 and sets another digital shadow 32S as the digital shadow 32S that is another search target. In a case where the CPU 28A of the cloud server 22 makes a negative determination in step S410, the CPU 28A ends the extraction of the metadata 44M and proceeds to sequence F306.

Next, in sequence F306, the cloud server 22 transmits the metadata 44M extracted in sequence F304, the metadata request history data 48HM, and the image data request history data 48HR to the machine learning apparatus 50. Then, the machine learning apparatus 50 specifies the image forming apparatus 32 that records the image data 44 used for machine learning in the storage 38D from the list of metadata 44M received in sequence F306.

Next, in sequence F308, the machine learning apparatus 50 requests the cloud server 22 to respond as to whether or not the image data 44 used for machine learning can be provided.

Next, in sequence F310, the cloud server 22 requests the image forming apparatus 32, which records the image data 44 requested by the machine learning apparatus 50 in sequence F308 in the storage 38D, to respond as to whether or not the image data 44 can be provided.

Next, in sequence F312, the image forming apparatus 32 determines whether or not the image data 44 requested in sequence F310 can be provided. More specifically, the CPU 38A of the image forming apparatus 32 determines whether or not the image data 44 requested in sequence F310 can be provided for security.

Next, in sequence F314, the image forming apparatus 32 replies to the cloud server 22 as to whether or not the image data 44 requested in sequence F310 can be provided. In this description, any image forming apparatus 32 replies that the image data 44 can be provided.

Next, in sequence F316, the cloud server 22 replies to the machine learning apparatus 50 as to whether or not the image data 44 received in sequence F314 can be provided.

Next, in sequence F318, the machine learning apparatus 50 requests the digital shadow 32S that replies that the image data can be provided to provide the image data 44.

Next, in sequence F320, the cloud server 22 transmits the request for providing the image data 44 received in sequence F318 to the image forming apparatus 32 that stores the image data 44 in the storage 38D. Further, the CPU 28A of the cloud server 22 records the history in which the image data 44 is requested from the machine learning apparatus 50 in sequence F318 in the storage 28D as the image data request history data 48HR.

Next, in sequence F322, the image forming apparatus 32 transmits the image data 44 requested in sequence F320 to the cloud server 22.

Next, in sequence F324, the cloud server 22 transmits the image data 44 received in sequence F322 to the machine learning apparatus 50.

Next, in sequence F326, the image forming apparatus 32 transmits, to the cloud server 22, a notification that the transmission of the image data 44 transmitted in sequence F322 has been completed.

Next, in sequence F328, the cloud server 22 transmits, to the machine learning apparatus 50, a notification that the transmission of the image data 44 transmitted in sequence F324 has been completed.

Next, in sequence F330, the machine learning apparatus 50 starts executing machine learning based on the image data 44 received in sequence F328.

Next, in sequence F332, the machine learning apparatus 50 records the created learned model in the recording device 54 in a case where the machine learning started in sequence F330 is completed.

The machine learning apparatus 50 may determine whether or not to execute the procedures after sequence F308 based on the metadata request history data 48HM and the image data request history data 48HR received from the cloud server 22 in sequence F306. More specifically, based on the metadata request history data 48HM and the image data request history data 48HR received from the cloud server 22 in the sequence F306, the image data 44 having a history of which provision has been previously requested may be set not to be requested. For example, in a case where the machine learning apparatus 50 determines that there is no new image data 44 to be used for learning from the metadata request history data 48HM received in sequence F306, the machine learning apparatus 50 ends the series of procedures without executing the procedures after sequence F308. Further, for example, in a case where the machine learning apparatus 50 determines that there is no new image data 44 to be used for learning from the image data request history data 48HR received in sequence F306, the machine learning apparatus 50 ends the series of procedures without executing the procedures after sequence F308.

Subsequently, the operation and the effect of the cloud server 22 provided in the machine learning system 10 according to the present exemplary embodiment will be described.

### Operation and Effect

The cloud server 22 of the present exemplary embodiment includes the storage 28D that records the metadata 44M associated with image data 44 generated by the image forming apparatus 32. Then, in a case where the machine learning apparatus 50 requests the metadata 44M, the CPU 28A of the cloud server 22 transmits the metadata 44M recorded in the storage 28D to the machine learning apparatus 50, and makes the image data 44 available to the machine learning apparatus 50. Accordingly, with the cloud server 22 according to the present exemplary embodiment, the image data 44 generated by the image forming apparatus 32 that may not directly communicate with the machine learning apparatus 50 and stored in the storage 38D of the image forming apparatus 32 may be made available to the machine learning apparatus 50.

Further, in a case where the machine learning apparatus 50 requests the image data 44 related to the metadata 44M, the CPU 28A of the cloud server 22 of the present exemplary embodiment makes the image data 44 available to the machine learning apparatus 50. Accordingly, with the cloud server 22 according to the present exemplary embodiment, the image data 44 stored in the image forming apparatus 32 that may not directly communicate with the machine learning apparatus 50 may be made available to the machine learning apparatus 50.

In addition, the CPU 28A of the cloud server 22 of the present exemplary embodiment receives the image data 44 from the image forming apparatus 32 that stores the image data 44, and transmits the image data 44 to the machine learning apparatus 50. Therefore, with the cloud server 22 according to the present exemplary embodiment, the image data 44 stored in the image forming apparatus 32 that may not directly communicate with the machine learning apparatus 50 may be made available to the machine learning apparatus 50.

Further, the CPU 28A of the cloud server 22 of the present exemplary embodiment records the history in which the image data 44 is requested from the machine learning apparatus 50 in the storage 28D as the image data request history data 48HR. Accordingly, with the cloud server 22 according to the present exemplary embodiment, as compared with the case where the history of transmitting the image data 44 to the machine learning apparatus 50 is not recorded, it is possible to notify the machine learning apparatus 50 that the machine learning apparatus 50 is repeatedly requesting the same image data 44. In other words, with the cloud server 22 according to the present exemplary embodiment, it is possible to notify the machine learning apparatus 50 that the requested image data 44 is already available.

Furthermore, the CPU 28A of the cloud server 22 of the present exemplary embodiment records metadata 44M in the storage 38M each time the image forming apparatus 32 generates the image data 44. Accordingly, with the cloud server 22 according to the present exemplary embodiment, as compared with the case where the metadata 44M is generated at a different time from the generation of the image data 44, the time at which the machine learning apparatus 50 may use the image data 44 may be brought forward.

Further, the CPU 28A of the cloud server 22 of the present exemplary embodiment adds a history in which the image data 44 is deleted to the metadata 44M in a case where the image data 44 related to the metadata 44M is deleted. Accordingly, with the cloud server 22 according to the present exemplary embodiment, in a case where the image data 44 related to the metadata 44M is deleted from a storage device, compared with a case where the metadata 44M recorded in the storage 38M is retained, it is easier to complete the availability process normally.

Further, in a case where the machine learning apparatus 50 requests the metadata 44M, the program of the present exemplary embodiment causes the CPU 38A to execute a process of transmitting the metadata 44M recorded in the storage 38M to the machine learning apparatus 50. That is, the program causes the CPU 38A to execute a process of causing the machine learning apparatus 50 to handle the image data 44 associated with the metadata 44M. Accordingly, with the program according to the present exemplary embodiment, a program for making the image data 44 stored in an area that may not be accessed by the machine learning apparatus 50 available to the machine learning apparatus 50 may be obtained.

Subsequently, a second exemplary embodiment of the present disclosure will be described. Since the configuration of the machine learning system 10 according to the second exemplary embodiment is the same as the configuration of the first exemplary embodiment, the same reference numerals as the components of the first exemplary embodiment will be used, and specific descriptions thereof will be omitted.

### Second Exemplary Embodiment

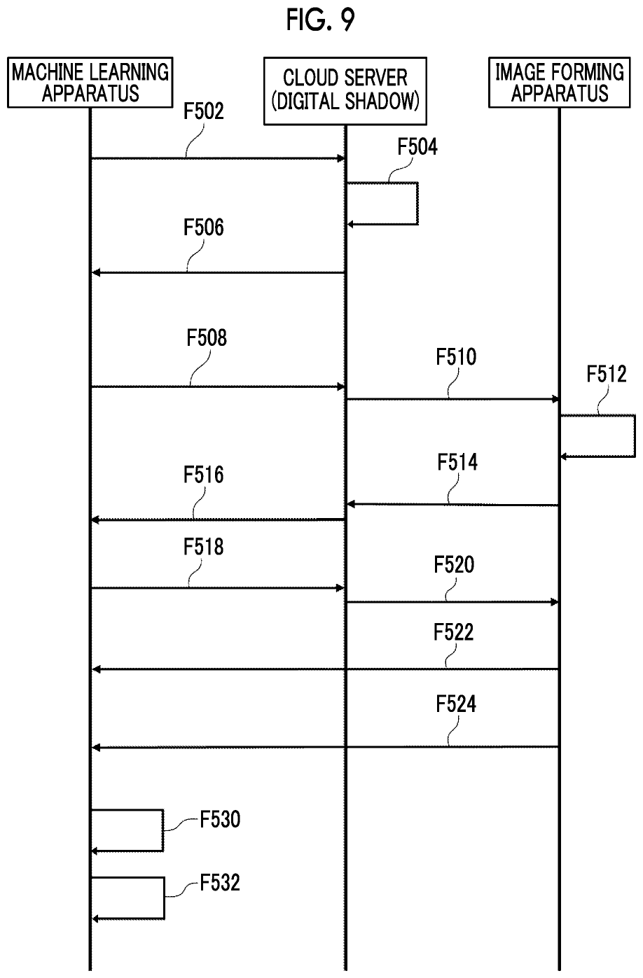

In the machine learning system 10 according to the second exemplary embodiment, as shown in FIG. 9, a procedure for making the image data 44 of the image forming apparatus 32 available to the machine learning apparatus 50 is different from the procedure of the first exemplary embodiment.

### Procedure for Making Image Data 44 Available

In FIG. 9, the procedure from sequence F502 to sequence F518 is the same as the procedure from sequence F302 to sequence F318 in the first exemplary embodiment.

In sequence F520, the cloud server 22 requests the image forming apparatus 32 that stores the image data 44 in the storage 28D to transmit the image data 44 received in sequence F518 to the machine learning apparatus 50. More specifically, in sequence F520, the cloud server 22 notifies the image forming apparatus 32 that stores the image data 44 in the storage 28D of information including a network address of the machine learning apparatus 50, authentication information, and the like. Further, in sequence F520, the cloud server 22 requests the image forming apparatus 32 to transmit the image data 44 to the machine learning apparatus 50 together with the notification.

Next, in sequence F522, the image forming apparatus 32 transmits the image data 44 requested in sequence F520 to the machine learning apparatus 50.

Next, in sequence F524, the image forming apparatus 32 transmits, to the machine learning apparatus 50, a notification that the transmission of the image data 44 transmitted in sequence F522 has been completed.

The procedure from sequence F530 to sequence F532 is the same as the procedure from sequence F330 to sequence F332 in the first exemplary embodiment.

Subsequently, the operation and the effect of the cloud server 22 provided in the machine learning system 10 according to the present exemplary embodiment will be described.

### Operation and Effect

In the information processing system according to the present exemplary embodiment, the CPU 28A of the cloud server 22 causes an apparatus that stores the image data 44 to transmit the image data 44 to the machine learning apparatus 50. Accordingly, with the information processing system according to the present exemplary embodiment, as compared with the case where the CPU 28A of the cloud server 22 receives the image data 44 and transmits the image data 44 to the machine learning apparatus 50, the time required for the machine learning apparatus 50 to receive the image data 44 may be shortened.

Further, also in the present exemplary embodiment, the components having the same configuration as the first exemplary embodiment can obtain the same operation and effect as the first exemplary embodiment.

Subsequently, a third exemplary embodiment of the present disclosure will be described. Since the configuration of the machine learning system 10 according to the third exemplary embodiment is the same as the configuration of the first exemplary embodiment or the second exemplary embodiment, the same reference numerals as the components of the first exemplary embodiment or the second exemplary embodiment will be used, and specific descriptions thereof will be omitted.

### Third Exemplary Embodiment

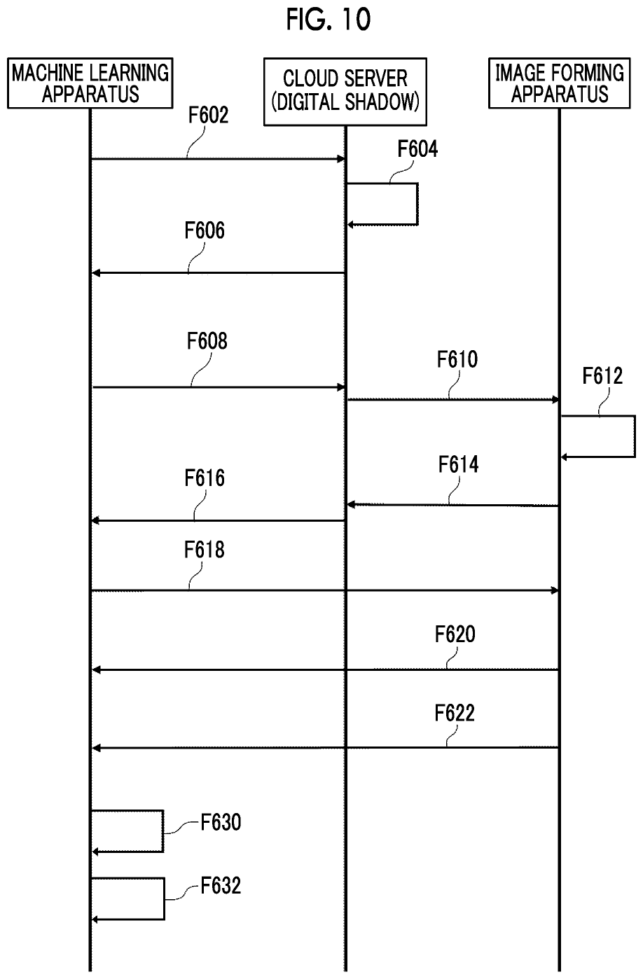

In the machine learning system 10 according to the third exemplary embodiment, as shown in FIG. 10, a procedure for making the image data 44 of the image forming apparatus 32 available to the machine learning apparatus 50 is different from the procedures of the first exemplary embodiment and the second exemplary embodiment.

### Procedure for Making Image Data 44 Available

In FIG. 10, the procedure from sequence F602 to sequence F614 is the same as the procedure from sequence F302 to sequence F314 in the first exemplary embodiment.

In sequence F616, in a case where the image data 44 received in sequence F614 can be provided, the cloud server 22 transmits a method for accessing a storage area of the image forming apparatus 32 that stores the image data 44 in the storage 38D to the machine learning apparatus 50. More specifically, in sequence F616, the cloud server 22 transmits information including the network address of the machine learning apparatus 50, authentication information, and the like for the image data 44 together with the result of whether or not the image data 44 received in sequence F614 can be provided.

Next, in sequence F618, the machine learning apparatus 50 requests the image forming apparatus 32 that stores the image data 44 requested in sequence F614 in the storage 38D to provide the image data 44 based on the information received in sequence F616.

Next, in sequence F620, the image forming apparatus 32 transmits the image data 44 requested in sequence F618 to the machine learning apparatus 50.

Next, in sequence F622, the image forming apparatus 32 transmits, to the machine learning apparatus 50, a notification that the transmission of the image data 44 transmitted in sequence F620 has been completed.

The procedure from sequence F630 to sequence F632 is the same as the procedure from sequence F330 to sequence F332 in the first exemplary embodiment.

Subsequently, the operation and the effect of the cloud server 22 provided in the machine learning system 10 according to the present exemplary embodiment will be described.

In a case where the machine learning apparatus 50 requests the metadata 44M, the CPU 28A of the cloud server 22 of the present exemplary embodiment transmits, to the machine learning apparatus 50, the method for accessing the storage area in which the image data 44 is stored together with the metadata 44M. Therefore, with the cloud server 22 according to the present exemplary embodiment, as compared with the case where the CPU 28A of the cloud server 22 receives the image data 44 and transmits the image data 44 to the machine learning apparatus 50, the time required for the machine learning apparatus 50 to be able to use the image data 44 may be shortened.

Further, the CPU 28A of the cloud server 22 of the present exemplary embodiment records the history in which the metadata 44M is requested from the machine learning apparatus 50 as the metadata request history data 48HM. Therefore, with the cloud server 22 according to the present exemplary embodiment, as compared with the case where the history of transmitting the image data 44 to the machine learning apparatus 50 is not recorded, it is possible to notify the machine learning apparatus 50 that the machine learning apparatus 50 is repeatedly requesting the same image data 44. In other words, with the cloud server 22 according to the present exemplary embodiment, it is possible to notify the machine learning apparatus 50 that the requested image data 44 is already available.

Further, also in the present exemplary embodiment, the components having the same configuration as the first exemplary embodiment or the second exemplary embodiment can obtain the same operation and effect as the first exemplary embodiment or the second exemplary embodiment.

### Other Modification Examples

In the above description, the CPU 28A of the cloud server 22 stores the metadata 44M in the storage 38M each time the image forming apparatus 32 generates the image data 44, but the technology according to the present disclosure is not limited thereto. For example, the CPU 28A of the cloud server 22 may not store the metadata 44M until a plurality of image data 44 are generated. Further, for example, the CPU 28A of the cloud server 22 may periodically access the image forming apparatus 32 and, in a case of determining that new image data 44 has been generated, create metadata 44M and store the metadata 44M in the storage 38M (so-called batch processing).

Further, in the above description, the CPU 28A of the cloud server 22 stores the history in which the image data 44 is requested from the machine learning apparatus 50 in the storage 28D as the metadata request history data 48HM, but the technology according to the present disclosure is not limited thereto. For example, the CPU 28A of the cloud server 22 may not create the metadata request history data 48HM.

Further, in the above description, the CPU 28A of the cloud server 22 stores the history in which the metadata 44M is requested from the machine learning apparatus 50 in the storage 28D as the metadata request history data 48HM, but the technology according to the present disclosure is not limited thereto. For example, the CPU 28A of the cloud server 22 may not create the metadata request history data 48HM.

Further, in the above exemplary embodiment, the machine learning apparatus 50 is used as an example of the external apparatus, but the technology according to the present disclosure is not limited thereto. As an example of the external apparatus according to the exemplary embodiment of the present disclosure, for example, an apparatus that simply obtains statistics on the usage status of the image forming apparatus 32 may be used. That is, any apparatus that uses actual data (image data 44) generated by the image forming apparatus 32 in the present exemplary embodiment may be included in the external apparatus according to the exemplary embodiment of the present disclosure.

Further, in the above exemplary embodiment, the cloud server 22 that forms the digital shadow 32S is used as an example of the information processing system, but the technology according to the present disclosure is not limited thereto. As an example of the “information processing system” according to the exemplary embodiment of the present disclosure, for example, the recording device 54 that simply records the metadata 44M based on the image data 44 without creating the digital shadow 32S may be used. That is, any apparatus that records attribute data associated with the actual data generated by the image forming apparatus 32 in the present exemplary embodiment and makes the actual data available in a case where the attribute data is requested may be included in the information processing system according to the exemplary embodiment of the present disclosure.

Further, in the above exemplary embodiment, the cloud server 22 is described as being configured by a single apparatus, but the cloud server 22 may be configured by a plurality of apparatuses. That is, the “information processing system” in the present exemplary embodiment may be configured by a single apparatus or may be configured by a plurality of apparatuses.

Further, in the above exemplary embodiment, the machine learning system 10 is described as having a single cloud server 22, but the technology according to the present disclosure is not limited thereto. That is, the machine learning system 10 may have a plurality of cloud servers 22.

Further, in the above exemplary embodiment, the image data 44 of the image forming apparatus 32 is used as an example of the actual data, but the technology according to the present disclosure is not limited thereto. As an example of the “actual data” according to the exemplary embodiment of the present disclosure, for example, in addition to the image data 44, data created using a measurement apparatus including voice data and video data may be used, or data created artificially such as sentence data and modeling data may be used. Even in these cases, in a case where it is possible to associate with actual data as attribute data associated with actual data, the generation date and time of the actual data, the device that generated the actual data, other data created based on the actual data, and the like may be included in the “attribute data” according to the exemplary embodiment of the present disclosure. In other words, in a case where it is possible to communicate with the processor, an apparatus such as a measurement apparatus including voice and video, a sentence creation apparatus, and a modeling apparatus may also be included in the “apparatus that communicates with the processor” according to the exemplary embodiment of the present disclosure.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The processing executed by causing the CPU to read software (program) in the exemplary embodiment may be executed by various processors other than the CPU. Examples of the processors in this case include a programmable logic device (PLD) whose circuit configuration can be changed after the manufacturing, such as a field-programmable gate array (FPGA), and a dedicated electric circuit that is a processor having a circuit configuration exclusively designed for executing specific processing, such as an application specific integrated circuit (ASIC). In addition, processing may be executed by one of these various processors, or may be executed by a configuration of two or more processors of the same type or different types (for example, a combination of a plurality of FPGAs, a combination of a CPU and an FPGA, and the like). Further, the hardware structure of these various processors is, more specifically, an electric circuit in which circuit elements such as semiconductor elements are combined.

While an aspect in which the processing program is stored (installed) in advance in the storage is described in each of the exemplary embodiments, the present disclosure is not limited thereto. The program may be provided in a form stored on a non-transitory storage medium such as a compact disk read only memory (CD-ROM), a digital versatile disk read only memory (DVD-ROM), and a Universal Serial Bus (USB) memory. Further, the program may be downloaded from an external apparatus via a network.

Although the exemplary embodiments of the present disclosure have been described above with reference to the accompanying drawings, it is clear that anyone with ordinary knowledge in the field of the art to which the present disclosure belongs can come up with various modifications or applications within the scope of the technical ideas described in the claims, and it is understood that these also naturally belong to the technical scope of the present disclosure.

The aspects of the present disclosure will be further described below.

(((1)

An information processing system comprising:
one or a plurality of processors; and
one or a plurality of recording units that record attribute data associated with actual data generated by an apparatus that communicates with the processor,
wherein the processor is configured to:
   transmit the attribute data recorded in the recording unit to an external apparatus; and
   make the actual data available to the external apparatus in a case where the attribute data is requested from the external apparatus.
   (((2)))

The information processing system according to (((1))), wherein the processor is configured to:
make the actual data available to the external apparatus in a case where the actual data related to the attribute data is requested from the external apparatus.
   (((3)))

The information processing system according to (((2))), wherein the processor is configured to:
receive the actual data from the apparatus that stores the actual data; and
transmit the actual data to the external apparatus.
   (((4)))

The information processing system according to (((2))) or (((3))), wherein the processor is configured to:
cause the apparatus that stores the actual data to transmit the actual data to the external apparatus.
   (((5))

The information processing system according to any one of (((2))) to (((4))), wherein the processor is configured to:
record a history in which the actual data is requested from the external apparatus.
   (((6))

The information processing system according to (((1))), wherein the processor is configured to:
transmit, to the external apparatus, a method for accessing a storage area in which the actual data is stored together with the attribute data in a case where the attribute data is requested from the external apparatus.
   (((7)))

The information processing system according to (((6))), wherein the processor is configured to:
record a history in which the attribute data is requested from the external apparatus.
   (((8)))

The information processing system according to any one of (((1))) to (((7))), wherein the processor is configured to:
record the attribute data in the recording unit each time the apparatus generates the actual data.
   (((9)))

The information processing system according to any one of (((1))) to (((8))), wherein the processor is configured to:
add a history in which the actual data is deleted to the attribute data in a case where the actual data related to the attribute data is deleted.
   (((10)))

A program causing a computer to execute a process comprising:
transmitting attribute data recorded in a recording unit to an external apparatus; and
making actual data with which the attribute data is associated available to the external apparatus in a case where the attribute data is requested from the external apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
one or a plurality of processors; and
one or a plurality of recording units that record attribute data associated with actual data generated by an apparatus that communicates with the processor,
wherein the processor is configured to:
transmit the attribute data recorded in the recording unit to an external apparatus; and
make the actual data available to the external apparatus in a case where the attribute data is requested from the external apparatus.

2. The information processing system according to claim 1, wherein the processor is configured to:
make the actual data available to the external apparatus in a case where the actual data related to the attribute data is requested from the external apparatus.

3. The information processing system according to claim 2, wherein the processor is configured to:
receive the actual data from the apparatus that stores the actual data; and
transmit the actual data to the external apparatus.

4. The information processing system according to claim 2, wherein the processor is configured to:
cause the apparatus that stores the actual data to transmit the actual data to the external apparatus.

5. The information processing system according to claim 2, wherein the processor is configured to:
record a history in which the actual data is requested from the external apparatus.

6. The information processing system according to claim 1, wherein the processor is configured to:
transmit, to the external apparatus, a method for accessing a storage area in which the actual data is stored together with the attribute data in a case where the attribute data is requested from the external apparatus.

7. The information processing system according to claim 6, wherein the processor is configured to:
record a history in which the attribute data is requested from the external apparatus.

8. The information processing system according to claim 1, wherein the processor is configured to:
record the attribute data in the recording unit each time the apparatus generates the actual data.

9. The information processing system according to claim 1, wherein the processor is configured to:
add a history in which the actual data is deleted to the attribute data in a case where the actual data related to the attribute data is deleted.

10. The information processing system according to claim 2, wherein the processor is configured to:
add a history in which the actual data is deleted to the attribute data in a case where the actual data related to the attribute data is deleted.

11. The information processing system according to claim 3, wherein the processor is configured to:
add a history in which the actual data is deleted to the attribute data in a case where the actual data related to the attribute data is deleted.

12. The information processing system according to claim 4, wherein the processor is configured to:
add a history in which the actual data is deleted to the attribute data in a case where the actual data related to the attribute data is deleted.

13. The information processing system according to claim 5, wherein the processor is configured to:
add the history in which the actual data is deleted to the attribute data in a case where the actual data related to the attribute data is deleted.

14. The information processing system according to claim 6, wherein the processor is configured to:
add a history in which the actual data is deleted to the attribute data in a case where the actual data related to the attribute data is deleted.

15. The information processing system according to claim 7, wherein the processor is configured to:
add the history in which the actual data is deleted to the attribute data in a case where the actual data related to the attribute data is deleted.

16. The information processing system according to claim 8, wherein the processor is configured to:
add a history in which the actual data is deleted to the attribute data in a case where the actual data related to the attribute data is deleted.

17. A non-transitory computer readable medium storing a program causing a computer to execute a process comprising:
transmitting attribute data recorded in a recording unit to an external apparatus; and
making actual data with which the attribute data is associated available to the external apparatus in a case where the attribute data is requested from the external apparatus.

18. An information processing method comprising:
transmitting attribute data recorded in a recording unit to an external apparatus; and
making actual data with which the attribute data is associated available to the external apparatus in a case where the attribute data is requested from the external apparatus.
